(19) United States
(12) Patent Application Publication
(10) Pub. No.: US 2005/0190882 A1
(43) Pub. Date: Sep. 1, 2005

(54) Multi-spectral x-ray image processing

(76) Inventor: Edward L. McGuire, Mountain View, CA (US)

Correspondence Address: LEYENDECKER LEMIRE & DALEY, LLC, C/O PORTFOLIO IP P.O BOX 52057, MINNEAPOLIS, MN, 55402, US

(21) Appl. No.: 10/818,086

(22) Filed: Apr. 5, 2004

Related U.S. Application Data
(60) Provisional application No. 60/320,090, filed on Apr. 4, 2003.

(51) Int. Cl. G01T 1/36; G21K 5/10; G01N 23/223; G01N 23/201

(52) U.S. Cl. 378/88; 378/45

(57) ABSTRACT

An x-ray generator capable of generating multiple selected spectra of x-rays to penetrate an object being studied is described. An x-ray detector designed so as to detect and/or image different x-ray spectra selectively is also described. Undesired spectral components can be rejected, and desired spectral components accepted for detection and/or imaging.

### REFERENCE TO RELATED APPLICATIONS

This application claims priority to the provisional application No. 60/320,090 filed on Apr. 4, 2003 entitled “Multi-spectral x-Ray image processing”, and having one of the inventors in common with this application. Further, the patent application no. entitled, “Multi-spectrum X-ray Generation” filed concurrently with this application, having the same inventor as this application, and claiming priority to a similarly named provisional application No. 60/320,088 filed on Apr. 4, 2003 is incorporated herein in its entirety. Additionally, this application incorporates patent application Ser. No. 10/748,961 entitled “Forward X-ray Generation”, which shares an inventor with the present invention, in its entirety.

### FIELD OF THE INVENTION

The present invention relates generally to the generation, detection and processing of X- rays and more particularly to a device and method for multi-spectral x-ray image processing and detection.

### BACKGROUND

Convention X-Rays as White Lights:

Existing x-ray imaging systems treat the x-ray generator as a highly penetrating source of white light. No attempt is made to generate a specific controlled x-ray spectrum (like a variable color-controlled spotlight), and no provision is made for attempting to perform spectrally sensitive processing of the x-rays penetrating the object being studied (like color filters or the use of color film). Conventional techniques correspond to black and white photography, so very little of the available information is being obtained.

Conventional Imaging Via Gross X-Ray Absorption:

Conventional x-ray systems measure only gross x-ray absorption. Consequently, a large thickness of slightly absorbing matter and a thin layer of strongly absorbing matter can yield the same image. A steel gun surrounded by a tight-fitting frame of cleverly arranged thin lead plate can image the same as an uninteresting rectangular plate of steel. This presents an unacceptable security risk.

Scattering of X-Rays:

When x-rays pass through matter, some of the radiation is scattered, causing its direction to change, and the energy (color) of the radiation to change. This often causes x-ray images to become foggy and indistinct, since some of the energy falling on a specific part of the image detecting system could have come from a variety of superfluous regions and energy of any sort of spectral make-up is allowed to contribute to the (color blind) imaging process.

### SUMMARY OF THE INVENTION

One preferred embodiment of the present invention describes a method of performing x- ray analysis on a body of unknown composition. The method comprises first bombarding the body with a plurality x-ray beams, each x-ray beam having unique line spectra, and then determining the compositional makeup of the body by detecting and analyzing x-rays reflected off of the body.

Another preferred embodiment of the present invention describes an apparatus for detecting and analyzing x-rays. The apparatus comprises an x-ray beam generator adapted to produce x-ray beams of varying line spectra and differing continuous spectrum wavelength composition. The apparatus also comprises a plurality of x-ray detectors and a plurality of x-ray radiation spectral filters. The filters are located in front of two or more of the plurality of x-ray generators. Additionally, the apparatus comprises a data processor for analyzing information from the detectors based on the x-ray beams produced by the x-ray beam generator.

Yet another embodiment of the present invention describes a method of analyzing x-rays reflected off of a body under study. The method comprises first illuminating the body with x-ray radiation. The x-rays reflected off of the body are filtered using a first spectral filter. The body is imaged utilizing the x-rays filtered through the first spectral filter. The x-rays reflected off of the body are also filtered using a second spectral filter and the body is imaged utilizing the x-rays filtered through the second spectral filter. Finally, the similarities and differences between the images are compared to estimate nuclear densities of materials in various locations of the body.

### BRIEF DESCRIPTION OF THE DRAWINGS

FIG. 1 is a simplified overall view of a multi-anode and multi-energy x-ray generator according to one embodiment of the present invention.

FIG. 2 is a simplified overall view of a multi-spectral x-ray image processing and/or detection system according to one embodiment of the present invention.

### DETAILED DESCRIPTION OF EMBODIMENTS OF THE INVENTION

An integrated multi-spectral x-ray system and a method of operating the system are described, wherein both the x-ray generator and the radiation detection and image formation system operate on multiple, controlled, and selected spectra of radiation in order to best extract the desired images and information.

The x-ray generator sub-system is capable of generating multiple selected spectra of x- rays to best penetrate an object being studied.

The x-ray detector sub-system is configured so as to best detect and/or image different x- ray spectra selectively. The x-ray detector sub-system is advised of the x-ray spectrum selected for emission by the controlled x-ray generator sub-system. Undesired spectral components are rejected, and desired spectral components are accepted for detection and/or imaging.

X-Ray Generation for Multi-Spectral Processing:

In order to facilitate multi-spectral x-ray image processing, control over the spectra emitted from x-ray generators is essential.

Generation of X-Rays:

X-rays are generated whenever a beam of high energy electrons strikes a metallic anode. The material of the anode emits a spectrum of x-rays, consisting of two components; a line spectrum of radiation characteristic of the anode material struck by the high energy electrons (only whenever the voltage is over a certain threshold), and a continuous spectrum which depends only on the value of the high voltage which accelerated the electrons.

Characteristic Line Spectrum:

In conventional systems, the characteristic line spectrum is ignored or filtered out as much as possible, and only the continuous spectrum radiation is used.

Each anode material generates (and will not absorb) a characteristic line spectrum which cannot be mistaken for that of any other material. A heavier anode material will generate characteristic lines at shorter wavelengths, and a lighter anode material will generate characteristic lines at longer wavelengths. There are no unknown nuclear materials: the line spectra are all recorded.

Therefore, precision matching of a selected radiation spectrum with the absorption spectrum of particular target materials allows absolutely unambiguous identification of those materials.

Unique Spectrum:

The line spectrum is unique and depends on the nuclear mass of the anode material. For each mass in the periodic table there is a line spectrum. No lines are exactly the same: it is as individual as a fingerprint. Also, no material absorbs its own line spectrum: only another material can do that.

Filtration of Characteristic Line Spectra:

For many useful anode materials, there is a corresponding second material which uniquely and specifically modifies (filters) the characteristic line spectrum of the first material. When used as a filter in front of the detector system, the usual modification is to eliminate one line of the spectrum of the emitting material. If there are two detectors, one with a filter and one without, a great difference can be recorded depending upon the presence of the single characteristic line in the radiation detected.

Anode Material Selection:

In conventional x-ray generators, although for heat dissipation purposes the anode may be composed of more than a single material, the electrons strike only a single anode material, therefore generating only a single characteristic line spectrum.

Multiple Anode Materials:

It is essential to be able to selectively generate the unique characteristic x-ray line spectra from a variety of target materials in order to facilitate material identification. To identify a particular material, it can be necessary to generate x-rays from a heavier and a lighter material in order to make a sure identification. In order to carry out this process rapidly enough to be useful, the multiple selected anode materials are typically to be incorporated into a single x-ray generator tube in embodiments of the present invention. Rapid selection of a particular anode material is accomplished by deflection of the electron beam by electric fields, magnetic fields, or a combination of both.

High Voltage Control:

The continuous spectrum portion of the radiation emitted from an x-ray generator tube is independent of the anode material. Its characteristics depend only on the high voltage which accelerated the electron beam striking the anode. Any change in the high voltage applied to the x-ray tube will alter the continuous x-ray spectrum emitted from it. Modem electronics can apply these changes with extreme speed.

Continuous X-Ray Color Control:

If selected differing high voltages are applied, selected differing x-ray spectra are generated. This can be thought of as a “color” control: higher voltages cause a shift toward “blue” x-rays; lower voltages cause a shift toward “red” x-rays.

Spectral Differencing:

By illuminating an unknown body with two different x-ray spectra (“colors”) and imaging the body with a spectrally insensitive method (“black and white film”) and comparing (subtracting) the two images, an assessment of the materials comprising the body can be made. This corresponds in an optical analog to the illumination of a body using two colors of light and taking two pictures using black and white film and comparing (subtracting) the two films. Even though the film is black and white, color information can be obtained since two colors of light were used for illumination.

Spectral Identification of Materials:

The identification of characteristic line spectra is unique. For example, it is possible to identify dangerous materials in air cargo containers and in luggage. Although this identification can be carried out by imaging methods in carry-on baggage, where there is little object overlap, and timely identification of materials could have timely importance, this identification can be carried out on large cargo containers without performing any imaging analysis, just by performing a spectral analysis, recognizing the lines. Non-imaging systems could alarm upon detecting the characteristic line spectra of controlled substances such as lead, arsenic, uranium, plutonium, etc. Any significant amount of such substances poses a threat that cannot be ignored or misunderstood.

Spectral Methods in Imaging:

By subtracting from one image a second image formed by a detection means optimized to detect scattered (interfering) radiation, the quality of the first image can be improved. The scattered radiation can be recognized by its wavelength shift as well as by its change of direction. Two differently “colored” images are being subtracted in this case. This corresponds in an optical analog to the case of illuminating an object with white light, and using either color film or color filters plus black and white films to form an image. In some cases, the scattered radiation may be the more significant, and the direct radiation may be considered to be “interfering”.

Integrated Multi-Spectral X-Ray System:

In the integrated system, both the x-ray generator and the radiation detection and image formation system form a integrated cooperative information gathering system such that the spectra of illuminating x-rays can be controlled and selected for optimum results taking into account the composition of the object of interest and the difficulties in imaging and material identification being encountered.

The spectra of x-ray radiation being used for object illumination in embodiments of the invention falls under automatic and/or operator control.

The imaging system selects from a multiplicity of image processing algorithms, advises the operator of the relative success obtained for each one, and displays the “best” image available.

Regions of the image are identified by material analysis of a combination of characteristic line spectra and differential continuous spectrum absorption analysis.

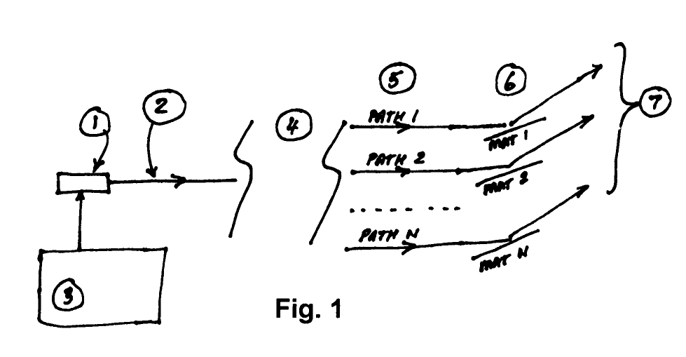

In FIG. 1, materials selected for use as anodes of the multi-spectrum x-ray generator are arranged so that they can be struck by a high energy electron beam (2) from a source of high energy electrons (1) whose energy is controlled by a variable high voltage power supply (3).

The path of the beam of high energy electrons (2) is deflected in region (4) by means of magnetic fields, electric fields, or a combination of magnetic and electric fields (hereinafter, “deflection fields”) being applied to the beam (2) in region (4).

The deflection of the beam (2) results in the beam taking a multiplicity of different paths (5) striking different selected anode materials (6) and causing them to emit different selected characteristic line and continuous spectrum radiation which is allowed to fall upon an unknown body under study.

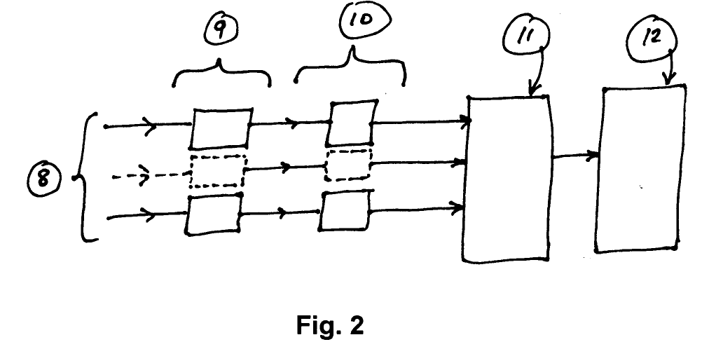

In FIG. 2, radiation (8), which has passed through or has been emitted from an unknown body under study, passes through a multiplicity of x-ray radiation spectral filters (9). A multiplicity of x-ray detectors and/or x-ray imagers (10) then detects the filtered radiation. Data processing system (11) processes the detected information into results which are presented by display system (12).

Operation of a Preferred Embodiment of the Invention

X-Ray Generator:

In FIG. 1, a source of high energy electrons (1) produces a beam of high energy electrons (2) which is accelerated by a variable high voltage power supply (3).

Multiple Anodes:

The path of the beam of high energy electrons (2) is deflected in region (4) by means of deflection fields being applied to the beam (2) in region (4).

As shown in FIG. 1, materials selected for use as anodes of the multi-spectrum x-ray generator are arranged so that they can be struck by the electron beam (2) when the beam is selectively deflected towards a particular anode material.

The deflection of the beam (2) results in the beam taking a multiplicity of different paths (5) striking different selected anode materials (6) and causing them to emit different selected characteristic line and continuous spectrum radiation.

In an embodiment, deflection fields are applied to beam (2) in region (4) in two transverse axes such that different whole anode assemblies in differing locations are selected by one deflection means (hereinafter, the “scan axis”), and different portions of a given anode (selectively), having different materials in different areas upon it, (hereinafter, the “material axis”) are selected by the other deflection means.

The deflection means along the “scan axis” selects the location along a line-of-scan from which radiation will be emitted, and the deflection means along the “material axis” selects the type of anode material which will be struck by the electron beam.

High Voltage Control:

The high voltage power supply is designed to be capable of extremely rapid variations, changing from one high voltage setting to any other in a period of time so short as to appear instantaneous in comparison with the physical beam deflection along the “scan axis” direction. The deflection systems are each designed so as to perform their positioning independently from any high voltage variations.

Wherever the beam strikes an anode material, the spectral characteristics of the radiation emitted can be controlled by variation of the high voltage power supply.

One effect of high voltage control is on the characteristic line spectrum which may be emitted from a given anode material. The characteristic line spectrum of any material has a number of particular wavelengths, called lines. Each line has a precise high voltage value, in kilovolts, associated with it. Only when the high voltage energy of the electron beam exceeds this value is that particular line in the spectrum emitted. If the high voltage is very high, several lines may simultaneously be emitted. Below a certain base threshold, no lines whatever are emitted. The kilovolt values for all lines of all materials are known and published, so exact control is possible.

Another effect of high voltage control is on the continuous or “white light”-like spectrum which is emitted by all anode materials. A significant feature of this type of x-ray emission is that the spectrum is truncated at the short wavelength end, at a wavelength which corresponds to the high voltage energy of the electron beam. No shorter wavelengths of radiation are emitted. When the high voltage varies, the short wavelength cutoff varies. This effect does not depend upon the anode material.

Gun Control:

In an embodiment, the source (1) of FIG. 1 can include a “triode gun”, which enables the beam of electrons to be controlled in intensity, and interrupted completely at any time, as can be advantageous to the operation of the x-ray system. Cutting off the electron beam completely can aid in keeping the beam from hitting elements in the deflection area which are not desired to be x-ray anodes, thereby eliminating undesired radiation or other effects. Gun control is independent of deflection and high voltage control.

Generator Summary:

The above described embodiment x-ray generator can generate any desired continuous x- ray radiation spectrum from any desired point along a line-of-scan. While holding position at any desired point along the line-of-scan, the generator can change continuous spectrum rapidly.

The above described embodiment x-ray generator also enables the generation of a multiplicity of selected characteristic line spectra from any desired point along a line-of-scan. While holding position at any desired point along the line-of-scan, the generator can selectively generate any or all of the characteristic lines of the selected anode material as may be desired.

Spectral Processes in X-Ray Imaging and Detection:

When a body under study is illuminated by x-rays, different and simultaneous physical processes occur. Among these are absorption, scattering, and fluorescence. Each element of x- ray radiation (photon) may only experience one process, but there are many photons, and several processes. Since the effect experienced by a photon may depend on its wavelength (color) and upon the precise atomic composition of the body under study, a great amount of information is available to a spectrally sensitive x-ray imaging system.

Absorption:

Conventional x-ray imaging and detection methods are based simply on x-ray absorption and are intentionally colorblind, although x-ray absorption is spectrally sensitive.

Scattering:

This process changes the direction of an x-ray photon as it travels through the body under study. Scattered radiation from unintended portions of the body causes the imaging to be cloudy and unclear. In a preferred embodiment, to suppress false (obscuring) image information, a wavelength (color) insensitive second imaging means is provided which only receives the false (scattered) image information, and no true (directly penetrating )image data. This scatter channel image information is then subtracted from the true channel image information.

Since scattering is due to the massiveness of atoms in the body under study, an estimate of the atomic density can be obtained from scattering data.

Spectral Method; Colorblind Detector, Colored X-Rays:

In an embodiment, the x-ray generator is made to illuminate a body under study with two different characteristic line spectra: one spectra of the material which may be of interest and which may be present in the body under study, and a second spectra of a similar but non- identical material. If the material of interest is present in the body under study, the images will be significantly different. An image formed by subtracting the two images will identify the physical areas where the material of interest is present, and a detection process which subtracts the responses from two color-blind detectors will show a non-zero response, indicating the presence of the material of interest in the body under study even in the absence of imaging.

Spectral Method; Color Detector, Colorblind X-Rays:

In an embodiment, the x-ray generator is made to illuminate a body under study with continuous spectrum x-ray radiation. In FIG. 2, the imaging system examines the radiation passing through the body through a variety of differing spectral filter means (9) forming separate images of how the materials in the unknown body react to a wide variety of x-ray wavelengths simultaneously. Heavy atoms scatter x-rays strongly (and absorb them too). Light atoms have little effect on high voltage x-rays, but much more effect on low voltage x-rays. The separate images produced by a multi-spectral filter imaging system carry in them estimates of the nuclear density of the physical areas of the body under study.

Spectral Method; Color Detector, Color X-Rays:

In an embodiment, the x-ray generator is made to illuminate a body under study with a multiplicity of characteristic line spectra corresponding to materials of interest which may be in the unknown body. A multiplicity of images is formed, both with and without spectral filter means corresponding to the characteristic line spectra of the illumination. The images are then processed to identify areas in the unknown body where a multiplicity of materials of interest is located, together with an estimate of the density of materials in those areas. That is, the identification of materials can be made separately from the measurement of gross absorption.

Fluorescence:

This process converts an illuminating x-ray photon of one wavelength (color) to a wavelength (color) characteristic of the matter with which the photon has interacted. If the body under study were being illuminated by a wide range of wavelengths, the fluorescent radiation will be obscured. In an embodiment using an x-ray generator which emits only known and carefully selected characteristic line spectra, and using a spectrally sensitive imager/detector system which is fully aware of the (possibly several) wavelengths present in the illumination, the unique fluorescent radiations from the body under study will identify the specific atomic materials present in the body through a recognition of their characteristic line spectra.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. A method of performing x-ray analysis on a body of unknown composition, the method comprising:
bombarding the body with a plurality x-ray beams, each x-ray beam having unique line spectra; and
determining the compositional makeup of the body by detecting and analyzing x- rays reflected off of the body.

2. The method of claim 1, wherein the plurality of x-ray beams comprise at least a first x-ray beam and a second x-ray beam, the first x-ray beam having a first characteristic line spectra that is distinct from a second characteristic line spectra of the second x- ray beam.

3. The method of claim 2, wherein the first x-ray beam is generated by bombarding an electron beam against a first anode material and the second x-ray beam is generated by bombarding the electron beam against a second anode material, the second anode material being different from the first.

4. The method of claim 1, wherein said determining the compositional makeup of the body further comprises detecting the x-rays reflected off of the body at two distinct detectors, wherein at least one detector filters the line spectra of at least one of the plurality of x-ray beams.

5. The method of claim 1, wherein said determining the compositional makeup of the body further comprises filtering at least one characteristic line spectra of the x-rays reflected off of the body.

6. The method of claim 1, further comprising varying the continuous spectrum of the plurality of x-ray beams by varying the voltage of the electron beam.

7. The method of claim 1, wherein said determining the compositional makeup of the body is performed without performing any x-ray imaging of the body.

8. The method of claim 1, wherein said bombarding the body with a plurality x-ray beams comprises bombarding the body with a first x-ray beam having a first characteristic line spectra and with a second x-ray beam having a second characteristic line spectra, the first characteristic line spectra being different from the second characteristic line spectra; and wherein said determining the compositional makeup of the body by detecting and analyzing x-rays reflected off of the body further comprises generating images from the x-rays reflected of the body for each of the first and second x-ray beams, and subtracting the two images to indicate the presence of a particular material in the body.

9. The method of claim 1 wherein said determining the compositional makeup of the body by detecting and analyzing x-rays reflected off of the body further comprises generating images for the x-rays reflected off of the body for each of the plurality of x-ray beams, and comparing the differences and similarities of the images to identify locations on the body where material compositions of interest are located.

10. The method of claim 1, wherein said determining the compositional makeup of the body by detecting and analyzing x-rays reflected off of the body further comprises detecting the fluorescence emanating from the body after the body has been bombarded with characteristic line spectra x-ray beams to identify the material present in the body.

11. An apparatus for detecting and analyzing x-rays comprising:
an x-ray beam generator adapted to produce x-ray beams of varying line spectra and differing continuous spectrum wavelength composition;
a plurality of x-ray detectors;
a plurality of x-ray radiation spectral filters, the filters being located in front of two or more of the plurality of x-ray generators; and
a data processor for analyzing information from the detectors based on the x-ray beams produced by the x-ray beam generator.

12. The apparatus of claim 11, wherein at least one of the detectors comprises a first x- ray imager.

13. The apparatus of claim 12, further comprising a first directional x-ray filter adapted to filter scattered x-rays, the directional x-ray filter being located in front of the first x- ray imager.

14. The apparatus of claim 13, further comprising a second directional x-ray filter adapted to detect primarily scattered x-rays, wherein at least a second of the detectors comprises a second x-ray imager, and wherein the second directional x-ray filter is located in front of the second x-ray imager.

15. The apparatus of claim 11, wherein the generator further includes a variable high voltage power supply adapted to rapidly change the voltage level of an electron beam generated therein.

16. The apparatus of claim 15, wherein the generator further includes an anode assembly comprising a plurality of different anode materials, each anode material adapted to generate an x-ray beam having unique characteristic line spectra when struck with the electron beam.

17. The apparatus of claim 16, wherein the generator further comprises an array of anode assemblies, and a deflection field controller, the deflection field controller including one or both a electric or magnetic field and being adapted to move the electron beam along the array of anode assemblies, the deflection controller being further adapted to selectively direct the electron beam to anyone of the plurality of different anode materials of a each anode assembly.

18. A method of analyzing x-rays reflected off of a body under study, the method comprising:
illuminating the body with x-ray radiation;
filtering the x-rays reflected off of the body using a first spectral filter;
imaging the body utilizing the x-rays filtered through the first spectral filter;
filtering the x-rays reflected off of the body using a second spectral filter;
imaging the body utilizing the x-rays filtered through the second spectral filter; and
comparing the similarities and differences between the images to estimate nuclear densities of materials in various locations of the body.

19. The method of claim 18, further comprising: filtering the x-rays reflected off of the body with one or more additional spectral filters; and imaging the body utilizing the x-rays filtered through each of the one or more additional spectral filters.

20. The method of claim 18, wherein the x-ray radiation is continuous spectrum radiation.
